(19) United States
(12) Patent Application Publication
(10) Pub. No.: US 2010/0317419 A1
(43) Pub. Date: Dec. 16, 2010

(54) Method and System for Synchronous Social Gaming via Mobile Devices

(76) Inventor: John Osborne, Incline Village, NV (US)

Correspondence Address: IAN F. BURNS & ASSOCIATES, 4790 Caughlin Parkway #701, RENO, NV, 89519-0907, US

(21) Appl. No.: 12/794,004

(22) Filed: Jun. 4, 2010

Related U.S. Application Data
(60) Provisional application No. 61/186,312, filed on Jun. 11, 2009.

(51) Int. Cl. A63F 9/24; A63F 13/00

(52) U.S. Cl. 463/1; 463/42; 463/30

(57) ABSTRACT

This invention allows multiple mobile devices to be wirelessly interconnected into a gaming environment intended specifically for use by a group of people in the same location, such as a bar, lounge or party. The game environment effectively utilizes motion sensors, keypads, or other user interface capabilities of disparate phone types and different display sizes so that different mobile device types be used. The games enhance and encourage social interaction instead of replacing it.

### CROSS REFERENCE TO RELATED APPLICATIONS

This application claims priority to U.S. provisional patent application Ser. No. 61/186,312 filed on Jun. 11, 2009, the contents of which is herein incorporated by reference.

### FIELD OF THE INVENTION

The present invention relates generally to the fields of computer systems, electronic games, and in particular games designed for social interaction via mobile devices.

### DESCRIPTION OF THE PRIOR ART

Electronic gaming systems and in particular mobile gaming devices have been in existence for years. The widespread popularity of multiplayer games interconnected over the Internet has led to significant decreases in social interaction amongst young people to the extent that online social networks have also sprung up to fill the gap. All of these online networks and environments only serve to increase the isolation felt by individuals and create a need for increased non-virtual social environments. It has been recognized, however, that these virtual social environments are successful because of their ease of entry with low psychological risk as well as their entertainment value, and a social setting must be engineered to compete with the benefits of a virtual environment in order to compete.

Some mobile gaming environments focus on the communications protocol required to provide secure gaming transactions for environments where the competition of the game represents tangible loss or reward such as casino games or gambling as described by Jakobsson, et al. (U.S. Pat. No. 7,340,058) or Papulov (U.S. Pat. No. 7,285,046). While secure communications may be utilized in any gaming environment, Jakobsson teaches the standard methodology of lone individuals linked to a gaming server. Other systems, such as Emmerson, et al. (U.S. Pat. No. 7,275,992) are a good example of a gaming platform that, while mobile, uses the interaction of one user with the device to move a gaming character on the game screen or board. These systems do not teach the social interaction of linking one or multiple characters between several devices used in concert. Other systems have evolved such as Gatto, et al. (U.S. Pat. No. 7,297,062) to lure players back to the arcade from solitary gaming, but these systems do not teach interconnecting games to enable actual social interaction.

The use of motion and acceleration sensors within games has gained acceptance through commercial gaming environments such as the Wii gaming console, and these motion sensor devices have now found their way into mobile devices both as sensors to indicate screen orientation and to enhance Global Positioning Systems (GPS) services. Ruha (U.S. Pat. No. 7,319,385) teaches the use of these sensors to enhace the interactive communication between two remote mobile terminals, but specifically does not address their use in an environment where the terminals are specifically and intentionally localized so that the physcial movement, actions, and verbalizations of the other users are part of the play experience. This verbal and physical interaction can be critical to a gaming environment, for example in the game of poker where non-verbal cues or “tells” may be critical in the game. Vale, et al. (U.S. Pat. No. 7,507,157) is an excellent example of the need for this non-verbal communication, by going to the extreme of representing some of this information such as shuffling chips or cards as digital information transmitted to other players.

In light of the significant decrease in social interaction that has followed the rise of individual or solitary gaming and online social networks, a need has arisen for gaming devices which can reduce social tension and anxiety in real social settings, as well as provide competitive and entertaining mediums for gaming to encourage and enhance social interaction.

### SUMMARY OF EMBODIMENTS OF THE INVENTION

### Advantages of One or More Embodiments of the Present Invention

The various embodiments of the present invention may, but do not necessarily, achieve one or more of the following advantages:

the ability to provide a social activity between nearby mobile device users; and

provide a game that encourages social interaction of nearby users;

provide an application that can replace the requirement for physical game pieces;

provide a social network for local interactions;

provide a hackey sack game that can be played between nearby users using mobile communications devices; and

provide a local social network for users of mobile devices irrespective of the device type.

These and other advantages may be realized by reference to the remaining portions of the specification, claims, and abstract.

### BRIEF DESCRIPTION OF ONE OR MORE EMBODIMENTS OF THE PRESENT INVENTION

In one aspect, there is provided a method for providing a social activity for a plurality of users, each user being associated with a personal mobile communication device. The method may comprise initializing the social activity by defining a location dependent social network. The location dependent social network may be limited to a plurality of the personal mobile communications devices that are within a required proximity of each other. The social activity may be conducted across the devices of the location dependent social network. The social activity may involve receiving individual user input from at least one of the networked mobile communications devices and generating at least one activity update in response to the user input. The activity updates may be shared between devices of the location dependent social network, allowing the updates to be represented on the displays of the networked devices.

In one aspect, there is provided a social gaming system comprising a plurality of personal mobile communication devices, each personal mobile communication device associated with a single user of a plurality of users. A social gaming application may be executed on the devices. When the application is executed, a game may be played between the devices. Play of the game may involve receiving user inputs to the social gaming application and sharing the user inputs to one or more of the mobile communications devices that are close enough to each other to participate in the game.

In one aspect, there is provided a mobile communications device configured to execute a social gaming application, that, when executed, causes the first mobile communications device to initialize and conduct a social game. Initializing the social game may comprise defining a location dependent social network comprising the first mobile communications device and one or more second mobile communications devices that are within a required proximity to the first mobile communications device.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF DRAWINGS

FIG. 1 is substantially a schematic view of a location dependent social network;

FIG. 2 substantially depicts a flowchart of a social activity method;

FIG. 3 substantially depicts an embodiment of a hackey sack game;

FIG. 4 substantially depicts a setup of the hackey sack game of FIG. 3; and

FIG. 5 substantially depicts a non-motion dependent social game.

### DESCRIPTION OF CERTAIN EMBODIMENTS OF THE PRESENT INVENTION

Turning now descriptively to the drawings, in which similar reference characters denote similar elements throughout several views, the attached figures illustrate a method for synchronous social gaming via mobile devices.

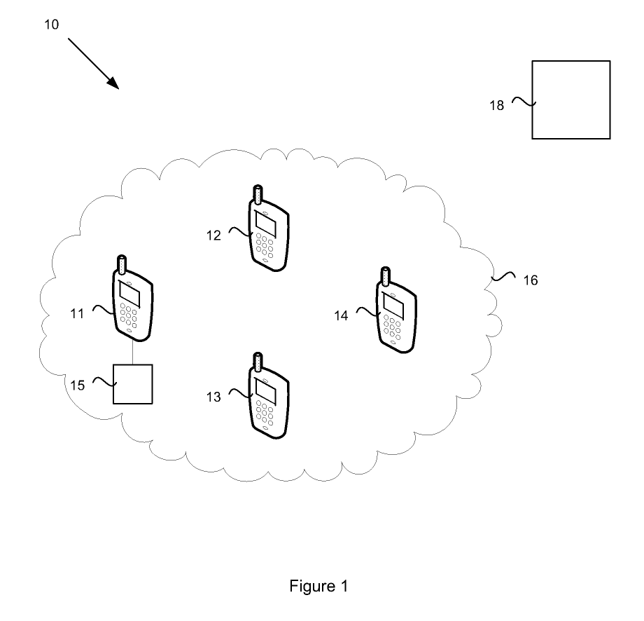

In FIG. 1 there is shown a system 10 having a plurality of personal mobile devices 11, 12, 13, 14, which, though depicted as mobile telephones in FIG. 1, may typically include mobile telephones, portable computers, hand-held browsers and the like. Each personal device 11, 12, 13, 14, includes one or more processors and one or more memories that can store one or more applications that can be executed by the processor(s) of the device for providing the communication functions of the device. In addition, each personal device 11, 12, 13, 14 may be configured to execute a social gaming application 15 that includes a proximity gaming component. The social gaming application 15 may be pre-installed on the mobile devices 11, 12, 13, 14 or may be downloaded to the mobile devices 11, 12, 13, 14 from an application server (not shown).

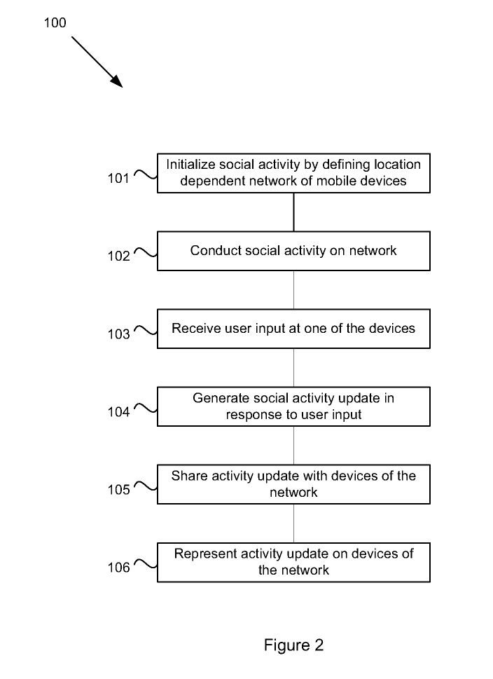

A method for providing a social activity on the mobile devices is depicted in the flowchart 100 of FIG. 2. At step 101, a social activity is initialized by defining a location dependent social network 16 comprising the mobile devices 11, 12, 13, 14. At step 102, the social activity is conducted by receiving individual user input from a first one of the networked devices (step 103), generating a social activity update based on the user input (step 104) and sharing the update amongst one or more of the networked devices (step 105). Each device that receives the update may display a representation that reflects the update on the respective device (step 106).

The mobile devices may be configured to interact with each other through any suitable protocol. In one embodiment, each of the mobile devices may be configured to employ a local or short range communications protocol, such as Zigbee, Bluetooth, Infrared Data Association (IRDA) etc. Alternatively, the mobile devices may be configured to communicate with each other via a telecommunications server 18.

The social gaming application 15 may execute an initialization phase in which participant devices are joined to the location dependent social network 16, thereby allowing users of the participant devices to engage in a social activity of the network. The location dependency can be defined based on a communication range of one or more of the participant devices or may be defined based on a distance or proximity to one or more of the devices, proximity to a server, proximity to a communal device, e.g. a display screen, etc. To encourage a physical social interaction, the required proximity may be that the devices are all within just a few metres of each other or within a line of site of each other. Other methods for defining the location dependency of the social network will be apparent to a person skilled in the art.

In one embodiment, the application 15 may be initialized from a first mobile device 11, which may act as a host for other participant devices 12, 13, 14. When the host device 11 executes the application, the host device 11 may broadcast an invite to participate in the social activity to other devices within a proximity of the host device 11. In one embodiment, the proximity of other devices may be determined as being those devices that can communicate with the host device on a short range protocol, such as the protocols mentioned above. Alternatively, the proximity of other devices may be determined by the server 18 using GPS or other location data received from or provided to the mobile devices. A combination of these methods is also possible as well as other methods that will be apparent to a person skilled in the art.

In one embodiment, a user of the host device 11 may select which devices in proximity of the host device can receive and/or respond to the invite.

When a non-host device 12, 13, 14 receives an invite, a user of the non-host device may respond by executing the application on the device and notifying an acceptance of the invite to the host device 11, e.g. by selecting a particular button on the accepting mobile device. In one embodiment, the acceptance notification may include a position of the accepting device. The positions of each of the accepting devices may be used to initialize relative spatial positions for use in the social activity, which may be performed at the host device 11, at another device of the social network or at the server 18, as will be described in greater detail below. Once the social activity has commenced, new participants that enter the proximity defined of the location dependent social network may request to join the network and thereafter participate in the social activity.

While the defining of the social network is described as being initiated from a host device, other methods for defining the location dependent social network will be apparent to a person skilled in the art. In one alternative embodiment, the defining of the social network may be driven by the server 18.

Participation in the social activity may not be limited to only mobile devices, but may also allow personal devices to join that are within an allowable proximity of the location dependent social network.

Once the social activity has been initialized, the social activity can commence. The activity application 15 may execute on each participant device to display aspects of the social activity. The display on any particular device may include a communal display that displays elements of the social activity that are common to all devices (or several of the devices) as well as a personalized display that displays elements of the social activity that are specific to that particular device and/or user.

As a part of the social activity, a user will provide on or more inputs. These inputs will generate activity updates which may be shared across the communications devices, thereby encouraging social interactions between the users of the various mobile devices. Each device of the network will receive the activity update and display a representation of the activity update on a display of the respective mobile device. The representation of an activity update may be dependent on the perspective of the participant device. For example, updates that are generated by the particular device may be displayed differently to updates that are received from other devices.

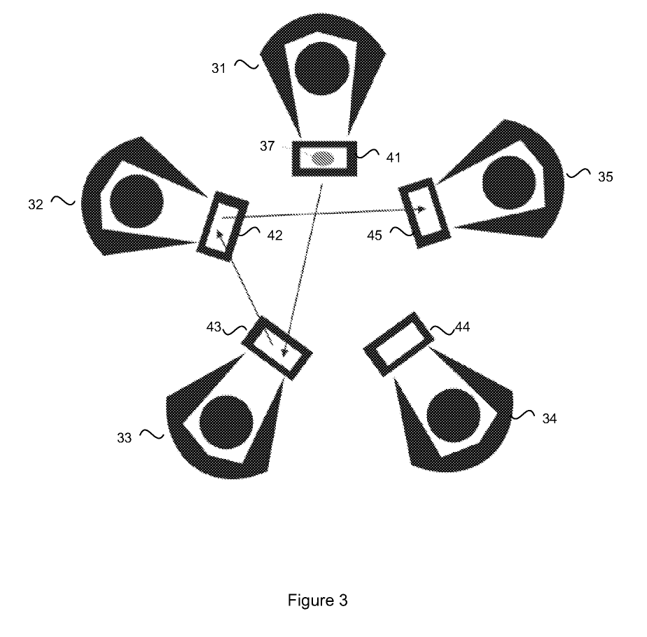

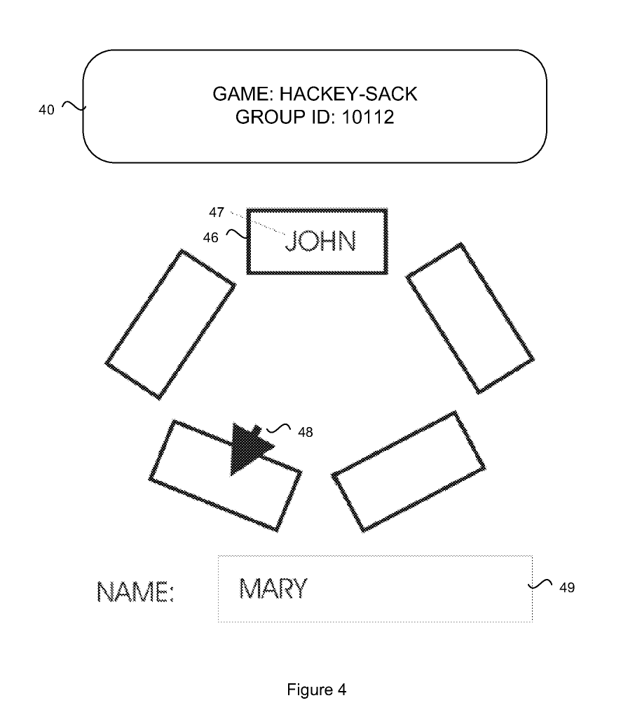

An example of a social activity will now be described with reference to FIG. 3. In this embodiment, five users 31, 32, 33, 34, 35 are engaged in a simultaneous game of “Hackey Sack”, where each user 31, 32, 33, 34, 35 has his or her own gaming device 41, 42, 43, 44, 45, mobile phone, Personal Digital Assistant (PDA), or other compatible system with input and display capability. The relative positioning of each player could be ascertained via Global Positioning System (GPS) or other location technology if sufficient accuracy can be obtained. If location sensing is not possible for one or more of the devices 41, 42, 43, 44, 45, the relative spatial positions may be defined at the initialization phase through the use of a setup screen (see FIG. 4) that allows the game user to explicitly identify his relative location. In this preferred embodiment, a game icon 37 of some type is represented on the screen of device 41. This icon 37 could be practically any size, shape or form, either two or three dimensional in depiction. In this preferred embodiment the icon 37 is a three-dimensional rendering of a hacky-sack ball complete with spin. The user 31 of the active device 41, i.e. the device having “possession” of the hackey sack ball, may transfer the possession to another of the participant devices by providing an input. The input is processed either locally at the active device or in a game server (not shown) to generate a game update that indicates the direction of travel of the ball. The game update is shared across the participant devices 41, 42, 43, 44, 45 either via completely local communications means such as bluetooth, zigbee, or Infrared Data Association (IRDA), or via a wireless network through an external server. The participant devices then display a representation of the game update on the respective device. For the device 43 that receives possession of the hackey sack 37, the representation will be that the receiving device is now the active device, which may be represented by additional effects such as various sounds, lights, color displays, etc. For the non-active devices, the representation of the game update will be a display of which device is now the active device, which may be shown in a communal display component of each of the non-active devices.

In one embodiment, the user input to transfer the hackey sack ball may be dependent upon motion of the active device generated by the user. When the user motions his gaming device, the speed, direction, and twist of the motion is registered by the mobile device. This motion causes a trajectory of the hackey sack to be determined, which is then transmitted to the other players. All of the devices register this trajectory of the hackey sack along with their relative locations, and the ball appears to transfer from one player's screen to another. In this example, the ball 37 is struck at a slight angle by user 31, sending the ball to user 33. User 33 pushes the ball with a 90 degree angle, sending the ball to user 32. User 32 strikes the ball with a slight angle, sending it to user 35, and so on. All aspects of the gaming environment can be simulated and modified for the users skill level, such as speed, curvature, etc. If a ball reaches the backside of the player's screen area without appropriate movement, the ball is “dropped” and the player's score is adjusted accordingly.

While the hackey sack game of FIG. 3 shows a single hackey sack icon 37 being transferred, a person skilled in the art will recognize the multiple hackey sack icons may be played simultaneously.

In FIG. 4, an example screen is shown which could be utilized for game setup and establishing the relative location of each player. The game screen displays a header 40 which may show the game title, number of players (selected from a previous menu or coded into the game), and other relevant information such as indication of the host device. The first player 46 to initiate the game is the host and is shown at the 12:00 position and his name is displayed 47 so that all other players may use that as their reference point. Other users e.g. user 49 enter their name and may indicate their position 48 relative to the host position 46. The name and position is then transmitted to the other gaming units of the network. Alternatively, the host device may perform the setup for all devices of the network. The setup may include additional icons for adding players, removing players, selecting the number of hackey sacks, etc. When all names are in place, play can commence.

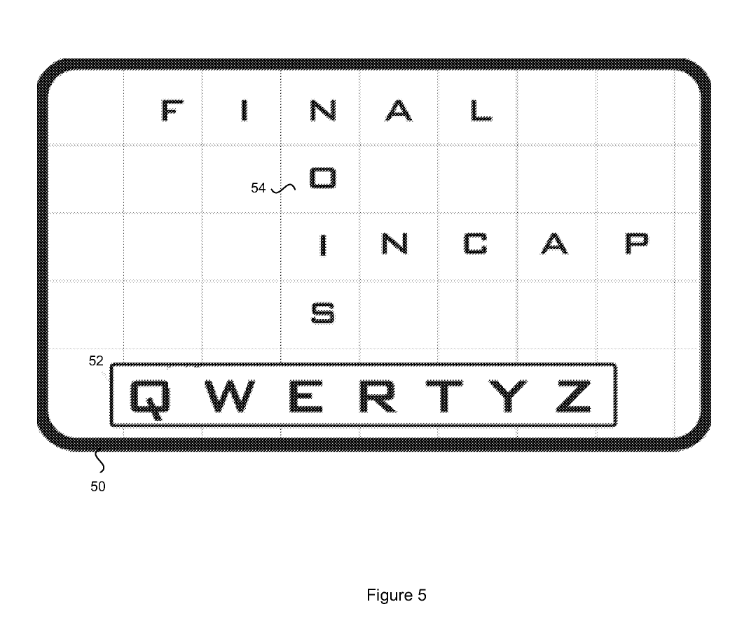

In FIG. 5, another embodiment is shown, where the gaming unit is acting solely as a game facilitator, with no motion sensors required. In these types of games, a common game board 50 or environment may be shown to each player, but additional play tokens that are specific to each player 52 are shown only on that player's device. In this preferred embodiment, a crossword style word game is being played. The user may see all or part of the game crossword 54 depending on his display capabilities, and can zoom and pan to see all of the board as required. The seven letters he has in play are shown below 52. Other game facets such as score, time in play, time of each play, etc. can all be displayed as well. When the active user takes his turn, he selects one or more of his game tokens to play from his personal display 52 onto the communal display 54. When the user selects to play his pieces onto the communal board, each participating display device is provided with a game update that causes the game board displays 54 of the devices to show the active users' selections.

This gaming replaces all of the physical game requirements so that any game is instantly available in any social environment. This format can supply playing cards and chips for Poker, game pieces for Chess, Checkers, Go, etc., or dice and scorecards for games such as Yahtzee.

The ability for the game to be played either via local or network wireless communications solves many of the bandwidth problems which might be experienced if gaming were carried out over relatively slow cellular network communications. This results in a best of both worlds scenario where the large capacity and availability of the games via the wireless network can be used to obtain and initialize gaming, but local transmission capability can provide additional communications bandwith.

In another embodiment, the gaming may be initiated and played via only localized transmission capabilities, with the gaming application stored on the phone. In another preferred embodiment the game could be completely handled via network communications.

In another embodiment, the game could rely on external sensors or accelerometers attached to the mobile device.

In another embodiment, the angle and relative location of the screen could provide alternative views of the virtual playing area, for example but not limited to, if the game device were held flat or parallel to the ground, the user would see the playing surface, and a ball as it came into his field of view. If the game device were held perpendicular to the ground (as if the eye were looking into it), it might display the entire 3-D perspective of the ball in flight from one user to another. In another embodiment the game might be played entirely by looking into the device as if it were a periscope, and the rotational angle of the device would determine its field of view.

In another embodiment, the game might require larger distances, where the game begins with the social group in one place, but they might then separate, tracking each other via GPS coordinates transmitted between the game units, for a scavenger hunt, for example.

In another embodiment the gaming device might be specifically manufactured to play a single game or multiple games, but not necessarily also be a computer, mobile phone, or PDA. The device would be capable of local transmission between similar devices but may or may not be able to connect to a wireless network.

In another embodiment, motion sensors might be used in game play even when the game itself does not require it per se, such as but not limited to throwing dice, requesting a “hit” in 21, folding a hand, or whenever motion in the non-virtual game might be simulated by motion within the virtual game environment.

In another embodiment the game environment may mix the capabilities of mobile phones wherein some may have motion sensors and others might not, allowing those with sensors to use movement for game actions where others might use a joystick, number keys, or keys on a QWERTY keyboard. The system would also adjust for differing screen sizes and capabilities so that the games run seamlessly independent of the devices being used by each member.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A method for providing a social activity for a plurality of users, each user being associated with a personal mobile communication device, the method comprising:
(A) initializing the social activity comprising:
(a) defining a location dependent social network comprising a plurality of the personal mobile communications devices within a required proximity of each other;
(B) conducting the social activity comprising:
(a) receiving individual user input from at least one of the networked mobile communications devices;
(b) generating at least one activity update in response to the user input;
(c) sharing the at least one activity update between a plurality of the networked mobile communications devices; and
(d) displaying a representation of the at least one activity update on a plurality of the networked mobile communications devices.

2. The method of claim 1 wherein initializing the social activity comprises:
(A) displaying at least one common display element on a plurality of the networked mobile communications devices; and
(B) displaying at least one personal display element on a plurality of the networked mobile communications devices, the at least one personal display element being specific to the respective networked communications device.

3. The method of claim 2 wherein the common display element provides a representation of the relative spatial positions of participants of the social activity.

4. The method of claim 1 wherein initializing the social activity comprises:
(A) ascertaining the relative spatial positions of the plurality of networked mobile communications devices; and
(B) representing the relative spatial positions on one or more displays of the networked mobile communications devices.

5. The method of claim 4 wherein the social activity comprises a game and wherein conducting of the game is dependent on the relative spatial positions of the plurality of network mobile communications devices.

6. The method of claim 5 wherein conducting the game comprises:
(A) displaying a game space on a display of each of the networked mobile communications devices that is a participant device of the game;
(B) representing the relative spatial positions of the participant devices on the game space;
(C) representing at least one game icon at a first participant device, the first selected participant device comprising an active participant device;
(D) receiving user input from the active participant device; and
(E) transferring the at least one game icon on the game space from the active participant device to a second participant device, wherein the second participant device is determined by the user input.

7. The method of claim 6 wherein the second participant device is determined by movement of the active participant device.

8. The method of claim 6 comprising displaying the at least one game icon in an active game display on the active participant device.

9. The method of claim 1 wherein initializing the social activity comprises:
(A) executing an application of the social activity from a first mobile communications device;
(B) determining one or more second mobile communications devices within a predetermined range of the first mobile communications device; and
(C) inviting the one or more second mobile communications device to participate in the social activity.

10. The method of claim 9 wherein initializing the social activity comprises specifying the relative spatial locations of the one or more second mobile communications devices relative to the first mobile communications device.

11. The method of claim 9 wherein the predetermined range is a distance from the first mobile communications device.

12. The method of claim 9 wherein the predetermined range is a communication range of a short range communications protocol of the first mobile communications device.

13. The method of claim 1 comprising representing a communal aspect of the social activity on a display of a first communications device and representing a personal aspect of the social activity that is specific to the first communications device on the display of the first communications device.

14. A social gaming system comprising:
(A) a plurality of personal mobile communication devices, each personal mobile communication device associated with a single user of a plurality of users;
(B) a social gaming application executable on the plurality of personal mobile communications devices, the social gaming application, when executed on a first mobile communication device of the plurality of mobile communications device, being configured to:
(a) allow play of a game between the first mobile communication device and one or more second mobile communications devices that are within a required range of the first mobile communications device;
(b) receive a user input to the social gaming application; and
(c) share the user input to one or more second mobile communications devices.

15. The social gaming system of claim 14 wherein the application when executed on the first mobile communications device is configured to:
(A) receive one or more updates of a game from one or more of the one or more second mobile communications devices; and
(B) represent the one or more updates on a display of the first mobile communications device.

16. The social gaming system of claim 14 wherein the application when executed on the first mobile communications device is configured to:
(A) display a communal state of the game on a display of the first mobile communications device; and
(B) display a state of the game specific to the first mobile communications device on the display of the first mobile communications device.

17. The social gaming system of claim 14 wherein the application when executed on the first mobile communications device is configured to:
(A) determine one or more of the second mobile communications devices that are within the required range of the first mobile communications device; and
(B) invite one or more of the in-range second mobile communications devices to participate in the game.

18. The social gaming system of claim 17 wherein the in-range second mobile communications devices are determined with reference to a communication range of a short range communications protocol.

19. The social gaming system of claim 17 wherein the in-range second mobile communications devices are determined by reference to a communications server that is communication with the one or more second mobile communications devices.

20. The social gaming system of claim 14 wherein the application, when executed on the first mobile communications device, is configured to display on a game space of a display of the first mobile communications devices, the relative locations of the first mobile communications device and the one or more second mobile communications devices that are participating in the game.

21. A first mobile communications device configured to execute a social gaming application, that, when executed, causes the first mobile communications device to:
(A) initialize the social gaming application by defining a location dependent social network comprising the first mobile communications device and one or more second mobile communications devices that are within a required proximity to the first mobile communications device; and
(B) conduct a game between the first mobile communications device and the one or more second mobile communications devices of the location dependent social network.

22. The first mobile communications device of claim 21 wherein the social gaming application is configured to conduct the game comprising sharing one or more user inputs of the game to the mobile communications devices of the location dependent social network.

23. The first mobile communications device of claim 22 wherein the one or more user inputs comprises movement inputs generated by movement of the first mobile communications device.

24. The first mobile communications device of claim 21 wherein the social gaming application is configured to:
(A) display a game space on a display of the first mobile communications devices; and
(B) display relative locations of the first mobile communications device and the one or more second mobile communications devices that are participating in the game.

25. The first mobile communications device of claim 21 wherein the social gaming application is configured to:
(A) ascertain the location of the one or more second mobile communications devices; and
(B) invite the one or more second mobile communications devices to participate in the game.
